(19) United States
(12) Patent Application Publication
(10) Pub. No.: US 2026/0356574 A1
(43) Pub. Date: Nov. 12, 2026

(54) PRODUCTION OF AN AEROSOL DISPENSING DEVICE WITH A RANGE OF NOZZLE INSERT TYPES

(71) Applicant: Weener Plastics Group B.V., Ede (NL)

(72) Inventors: Jolijn Marion Schoofs, Valkenswaard (NL); Henricus Johannes Cornelius Nuijen, Linden (NL)

(21) Appl. No.: 19/148,339

(22) PCT Filed: Jan. 18, 2024
(86) PCT No.: PCT/EP2024/051162

§ 371 Date: Jul. 16, 2025

(30) Foreign Application Priority Data
Jan. 23, 2023 (NL) 2034009

(51) Int. Cl. B65D 83/14; B05B 15/65; B65D 83/206

(52) U.S. Cl. CPC B65D 83/7532; B05B 15/65; B65D 83/206

(57) ABSTRACT

A method for producing an aerosol dispensing device includes providing an actuator adapted to operate a valve stem of a container and including a flow channel having an inlet end adapted to be coupled with the valve stem of the aerosol container and an outlet end. The actuator has a nozzle head at the outlet end of the flow channel, the nozzle head having a receiving chamber. A range of distinct nozzle insert types is provided, including at least two of the following nozzle insert types: a spray dispensing nozzle insert; a gel dispensing nozzle insert; and a foam dispensing nozzle insert. One of the nozzle insert types of the range is selected. The nozzle insert of the selected type is assembled with the actuator by positioning the nozzle insert in the receiving chamber of the nozzle head of the actuator.

### CROSS-REFERENCE TO RELATED APPLICATIONS

This application is the National Stage of International Application No. PCT/EP2024/051162, filed Jan. 18, 2024, which claims the benefit of Netherlands Application No. 2034009, filed Jan. 23, 2023, the contents of which is incorporated by reference herein.

### FIELD OF THE INVENTION

The invention relates to a method for producing an aerosol dispensing device adapted for placement on an aerosol container having a valve stem of an operable valve at the top of the container. The invention also relates to an aerosol dispensing device and an assembly of an aerosol container and an aerosol dispensing device.

### BACKGROUND OF THE INVENTION

From WO 2022/084459 A1 an aerosol dispensing device is known which is suitable to dispense a content of an aerosol as a spray. The dispensing device comprises an actuator, which is adapted to operate a valve stem of the aerosol container and a flow channel which guides the content from the valve stem to an outlet. At the outlet the actuator is provided with a spray nozzle insert. The spray nozzle insert is a separate part which is assembled with the actuator. The spray nozzle insert has a spray orifice and is adapted to transform the pressurized fluid flow from the container into a spray when it is ejected from the spray orifice.

In the prior art there are also known aerosol dispensing devices for dispensing other substances such as gel or foam, which have a dispensing outlet configuration which is formed in one piece with the actuator.

The present invention has for an object to allow a more economic production of different types of dispensing devices suitable for dispensing different types of substances.

This object is achieved by a method for producing an aerosol dispensing device according to the invention.

### SUMMARY OF THE INVENTION

A method for producing an aerosol dispensing device adapted for placement on an aerosol container having a valve stem of an operable valve at the top of the container, comprising the steps:
providing an actuator adapted to operate the valve stem of the container and including a flow channel having an inlet end adapted to be coupled with the valve stem of the aerosol container and an outlet end, wherein the actuator has a nozzle head at the outlet end of the flow channel, the nozzle head having a receiving chamber,
providing a range of different nozzle insert types, said range comprising at least two of the following different nozzle insert types:
   a spray dispensing nozzle insert,
   a gel dispensing nozzle insert,
   a foam dispensing nozzle insert,
selecting one of the nozzle insert types of the range,
assemble the nozzle insert of the selected type with the actuator by positioning the nozzle insert in the receiving chamber of the nozzle head of the actuator.

In the method according to the invention a common actuator can be used to manufacture dispensing devices for different substance types that can be dispensed from aerosol containers or pressurized containers. The invention thus advantageously uses only one common actuator, which according to need is combined in an assembly process with a specific nozzle insert for dispensing a specific substance. According to the invention a range comprising a plurality of nozzle insert types is provided. Such a range comprises at least two different nozzle insert types selected from a gel dispensing nozzle insert, a foam dispensing nozzle insert and a spray dispensing nozzle insert. These mutually different nozzle insert types are distinct from each other in that they have different features that make them suitable for dispensing one of a spray, a gel or a foam. From this range a nozzle type can be selected and a batch of it can be provided to produce a batch of dispensing devices for that specific type of substance to be dispensed. Thus, when for example dispensing devices have to be produced which are suitable for dispensing foam from an aerosol, a batch of common actuators is provided and a batch of foam dispensing nozzle inserts which are assembled to produce the aerosol dispensing device for dispensing foam. The assembled foam dispensing devices are fitted on an aerosol containing a foam producing substance.

The invention furthermore relates to an aerosol dispensing device for placement on an aerosol container having a valve stem of an operable valve at the top of the container, the aerosol dispensing device comprising:
an actuator adapted to operate the valve stem of the container and including a flow channel having an inlet end adapted to be coupled with the valve stem of the aerosol container and an outlet end, wherein the actuator has a nozzle head at the outlet end of the flow channel, the nozzle head having a central post and a circumferential wall concentrically surrounding the central post, the central post and the circumferential wall defining between them an annular chamber, wherein the central post has a flat end surface at which the outlet of the flow channel is located,
a gel dispensing nozzle insert comprising an end wall having an orifice therethrough, the end wall having an outer side and an inner side, wherein a first cylindrical wall connected to the inner side of the end wall is arranged surrounding the orifice, and wherein a second cylindrical wall connected to the outer side of the end wall is arranged surrounding the orifice,
the nozzle insert being positioned in the actuator, wherein the first cylindrical wall of the nozzle insert is located in the annular chamber of the nozzle head and the flat end surface of the central post is in abutment with the inner side of the end wall of the nozzle insert,
wherein the nozzle insert has at least two snap fingers located at a radial distance outside the first cylindrical wall, said snap fingers extending from the inner side of the end wall, wherein the actuator has at least two first guiding ribs spaced apart from an outer side of the circumferential wall of the nozzle head configured to guide each snap finger upon positioning the nozzle insert in the actuator, wherein the snap finger has a snap member which is snapped behind an inward end of the first guiding rib in a fully inserted state.

The invention also relates to an aerosol dispensing device for placement on an aerosol container having a valve stem of an operable valve at the top of the container, the aerosol dispensing device comprising:
an actuator adapted to operate the valve stem of the container and including a flow channel having an inlet end adapted to be coupled with the valve stem of the aerosol container and an outlet end, wherein the actuator has a nozzle head at the outlet end of the flow channel, the nozzle head having a central post and a circumferential wall concentrically surrounding the central post, the central post and the circumferential wall defining between them an annular chamber, wherein the central post has a flat end surface at which the outlet of the flow channel is located,
a foam dispensing nozzle insert comprising an end wall having an orifice therethrough, the end wall having an outer side and an inner side, wherein a cylindrical wall connected to the inner side of the end wall is arranged surrounding the orifice, and wherein a circumferential wall connected to the outer side of the end wall is arranged such that the orifice is located within the perimeter of the circumferential wall, and wherein parallel partition walls are formed within the perimeter of the circumferential wall, which partition walls each have ends that are connected to the circumferential wall and which partition walls define foam expansion chambers with the circumferential wall and the end wall, wherein the foam expansion chambers are open on a side remote from the end wall, and wherein the orifice is in communication which each one of the foam expansion chambers,
the nozzle insert being positioned in the actuator, wherein the first cylindrical wall of the nozzle insert is located in the annular chamber of the nozzle head and the flat end surface of the central post is in abutment with the inner side of the end wall of the nozzle insert,
wherein the nozzle insert has at least two snap fingers located at a radial distance outside the first cylindrical wall, said snap fingers extending from the inner side of the end wall, wherein the actuator has at least two first guiding ribs spaced apart from an outer side of the circumferential wall of the nozzle head configured to guide each snap finger upon positioning the nozzle insert in the actuator, wherein the snap finger has a snap member which is snapped behind an inward end of the first guiding rib in a fully inserted state.

Preferred embodiments of the invention are described herein.

The invention will be elucidated in the following detailed description with reference to the drawings.

### BRIEF DESCRIPTION OF THE DRAWINGS

FIG. 1 shows a front view in perspective of an embodiment of an aerosol cap according to the invention,

FIG. 2 illustrates in a cross sectional view the aerosol cap of FIG. 1 mounted on the container,

FIG. 3 shows a view from below in perspective of the aerosol cap of FIG. 1,

FIG. 4 in a view in perspective an embodiment of a cap including an actuator for an aerosol dispensing device according to the invention,

FIG. 5 illustrates in an elevated view from below how a nozzle insert is positioned in the cap of FIG. 1,

FIG. 6 shows in an elevated view from below that the nozzle insert is positioned in the cap of FIG. 1,

FIG. 7 shows a view in perspective from the front of a foam dispensing nozzle insert according to the invention,

FIG. 8 shows a top elevational view of the nozzle insert of FIG. 7,

FIG. 9 shows a side elevational view of the nozzle insert of FIG. 7,

FIG. 10 shows a rear elevational view of the nozzle insert of FIG. 7,

FIG. 11 shows a front elevational view of the nozzle insert of FIG. 7,

FIG. 12 shows another view in perspective of the nozzle insert of FIG. 7,

FIG. 13 shows a view in perspective from the rear of the nozzle insert of FIG. 7,

FIG. 14 shows a view in perspective from the front of a gel dispensing nozzle insert according to the invention,

FIG. 15 shows a top elevational view of the nozzle insert of FIG. 14,

FIG. 16 shows a side elevational view of the nozzle insert of FIG. 14,

FIG. 17 shows a rear elevational view of the nozzle insert of FIG. 14,

FIG. 18 shows a front elevational view of the nozzle insert of FIG. 14,

FIG. 19 shows another view in perspective of the nozzle insert of FIG. 14,

FIG. 20 shows a view in perspective from the rear of the nozzle insert of FIG. 14,

FIG. 21 shows a view in perspective from the front of a spray dispensing nozzle insert according to the invention,

FIG. 22 shows a view in perspective from the rear of the nozzle insert of FIG. 21,

FIG. 23 shows a top elevational view of the nozzle insert of FIG. 21,

FIG. 24 shows a side elevational view of the nozzle insert of FIG. 21,

FIG. 25 shows a rear elevational view of the nozzle insert of FIG. 21, and

FIG. 26 shows a front elevational view of the nozzle insert of FIG. 21.

### DETAILED DESCRIPTION

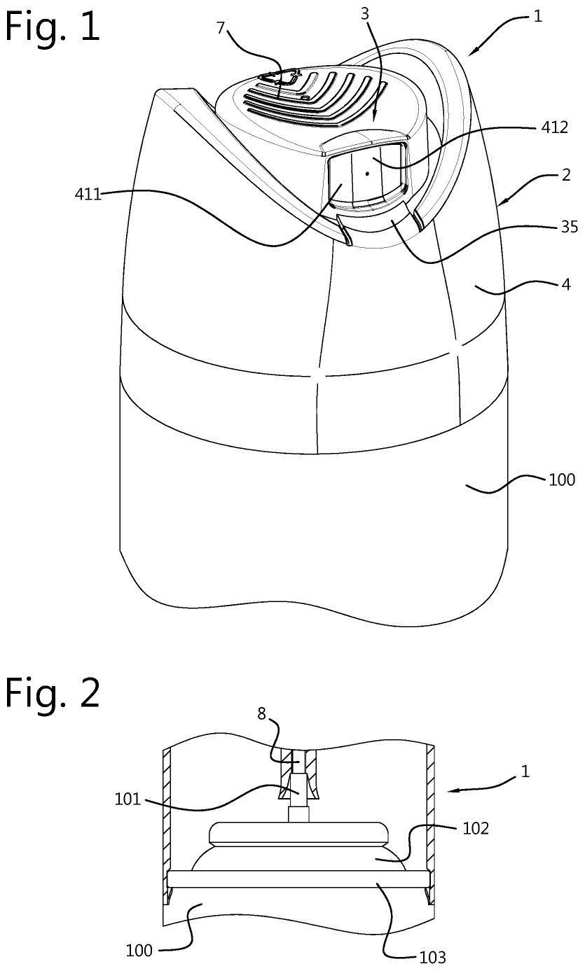

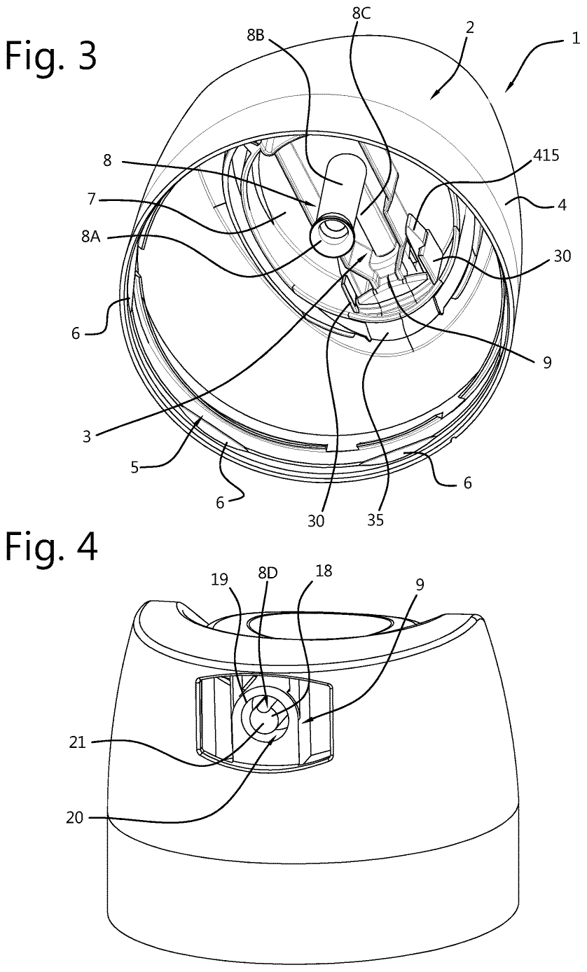

In FIGS. 1 and 2 is shown an aerosol dispensing device embodied as an aerosol cap 1 which is mounted on an aerosol container 100. FIG. 3 shows the cap 1 from below when it is not placed on the container.

The aerosol container 100 may typically be a substantially cylindrical metal (usually aluminium) can having an opening at a top end which is sealed by a valve cup 102. The valve cup 102 is attached to the container by a crimping connection. The valve cup 102 holds a valve assembly which includes a valve stem 101. The aerosol container may be an aerosol container that contains a product, e.g. a fluid, to be dispensed and a propellant gas mixed with the product to expel the product out of the container when the valve of the valve assembly is opened. Also other types of aerosol containers are possible, for example bag-on-valve type containers, in which the product to be dispensed, e.g. a fluid, is contained in a bag, which is arranged inside the container. The container around the bag is pressurized with compressed gas, e.g. air or nitrogen as propellant. The valve stem 101 is able to operate the valve when it is pushed in or sideways, such that the valve opens and the product, e.g. a fluid, is expelled from the container by a propellant gas. The valve stem 101 is a tubular member through which the fluid will flow. The valve stem may be the valve stem of a so called male valve, as is shown in FIG. 2, as well as of a female valve, which is well known for the person skilled in the art. The valve stem will in many applications be connected to a spray nozzle which forms the flowing fluid into a spray. The spray nozzle is often comprised in an aerosol spray cap.

The aerosol cap 1 comprises two main components: a cap body 2 and an actuator 3 which is moveable with respect to the cap body 2.

The cap body 2 comprises a circumferential wall 4 which defines an open end 5 at a bottom end of the body 2. Near the open end 5 the circumferential wall 4 has beads 6 (cf. FIG. 3) or other protrusions which can snap behind a ridge 103 of the container 100. The ridge 103 of the container can for example be formed by the crimped connection of the valve disc 102 connected to the spray can 100. Once the cap body 2 is snapped on the aerosol container, the cap body 2 of this particular embodiment cannot be pulled of the container again without the use of undue force.

The actuator 3 comprises a push button 7 and a flow channel 8 that is, at least in the shown embodiment, integrally formed on an underside of the push button 7. The flow channel 8 has an inlet end 8A which is colinear with the central axis of the cap body 2 of the aerosol cap 1. In the embodiment shown, the flow channel 8 has two perpendicular portions 8B and 8C adjoining each other. The inlet end 8A located at the end of the portion 8B of the flow channel 8 is suitable to be connected with the valve stem 101 of the aerosol container. When in use the push button 7 is pushed in, the flow channel 8 will be pushed towards the aerosol container whereby the valve stem 101 is pushed in. This opens the valve and content of the pressurized aerosol container 100 is ejected into the flow channel 8 at the inlet end 8A.

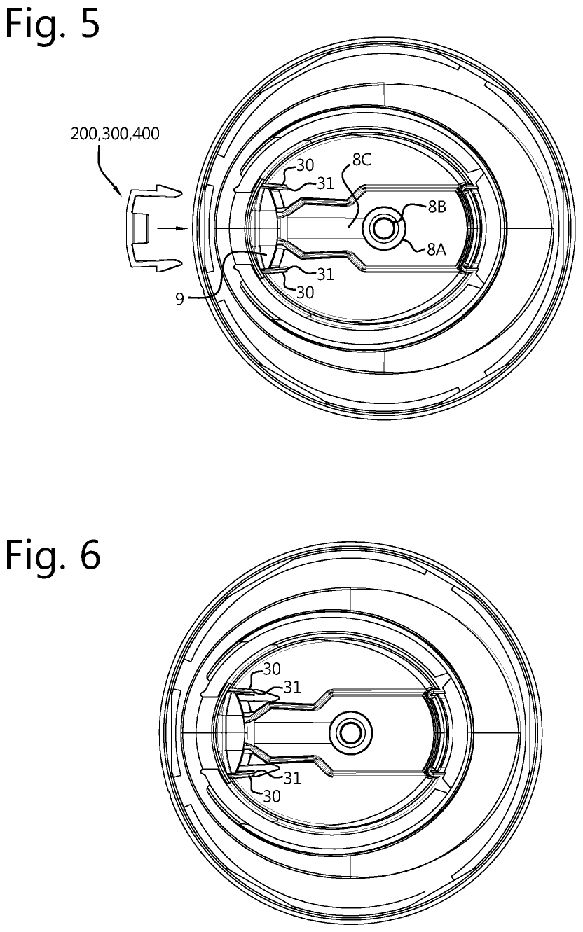

The flow channel 8 has an outlet end 8D. At the outlet end 8D a nozzle head 9 is formed as is best visible in FIGS. 4-6. The nozzle head 9 has a central post 18 and a circumferential wall 19 concentrically surrounding the central post 18. The central post 18 and the circumferential wall 19 define between them an annular chamber 20. The central post 18 has a flat end surface 21 at which the outlet of the flow channel 8 is located.

As can be seen in FIG. 4, the embodiment shown has a groove like flow channel outlet end 8D formed in the upper side of the post 18. In another possible embodiment, the outlet end may be a closed channel coaxial with the centre axis of the post 18.

A nozzle insert 10 is positioned in the actuator 3 at the nozzle head 9. The present invention proposes to assemble the aerosol device, in particular the aerosol dispensing cap with different types of nozzle inserts.

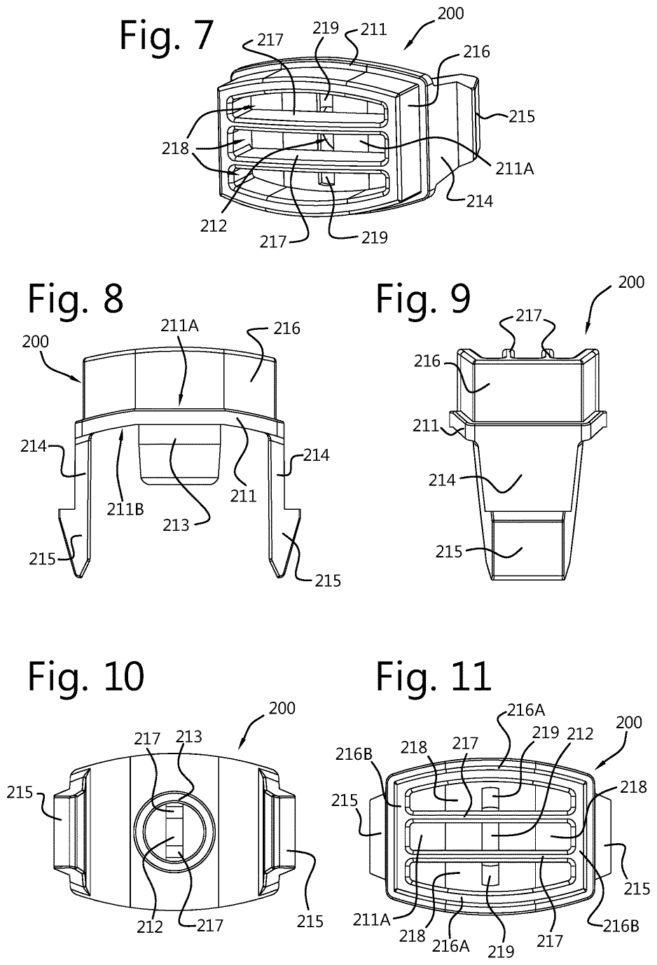

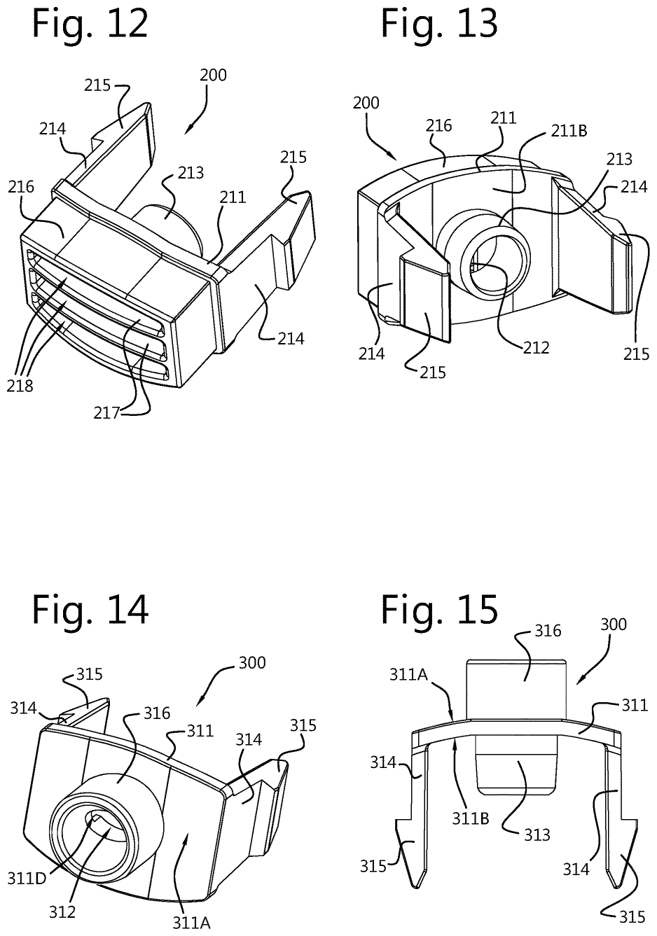

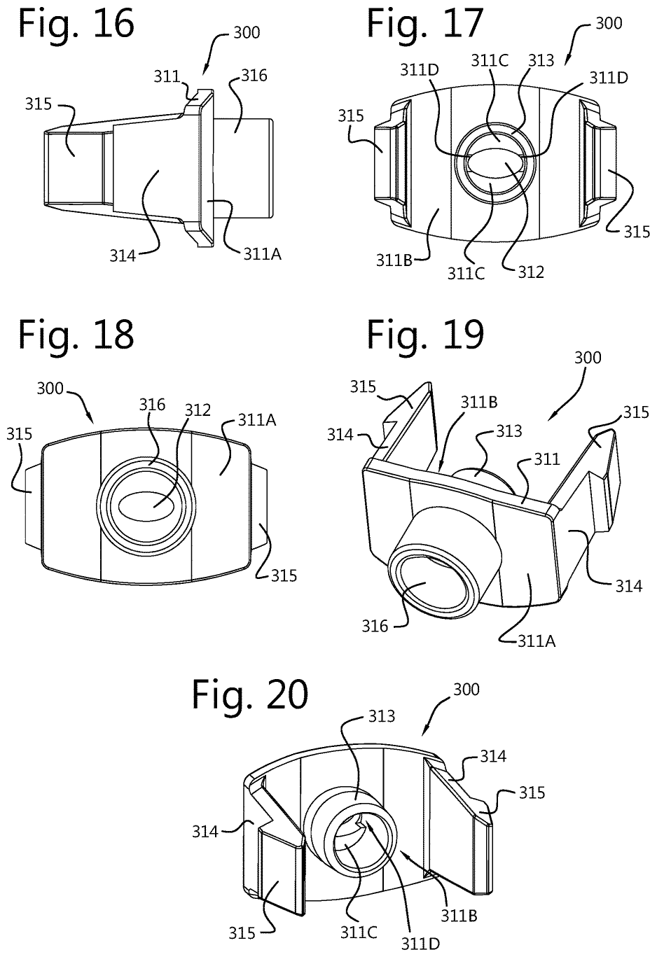

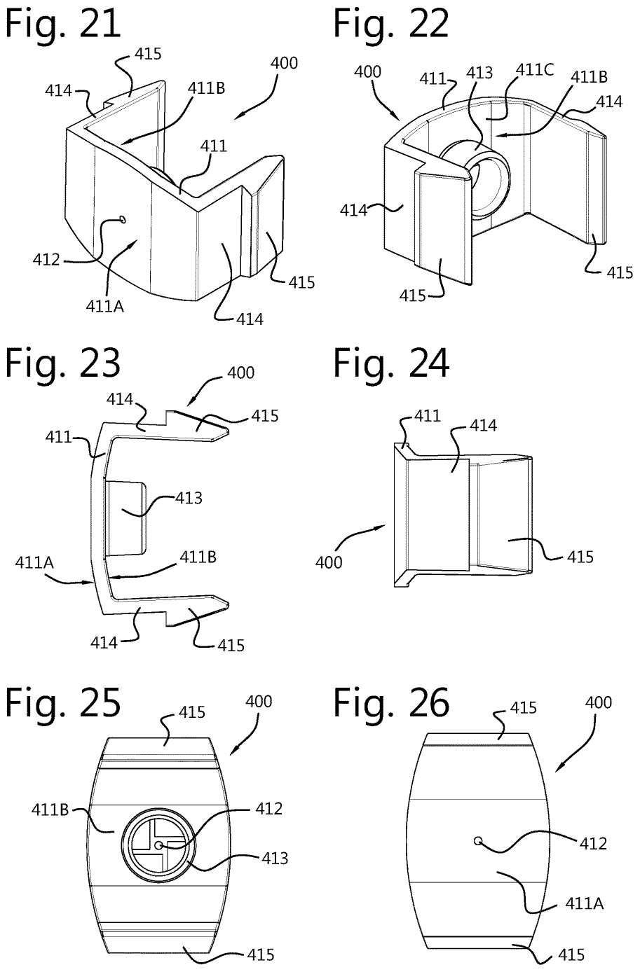

In particular it is proposed to provide a range of nozzle insert types, said range comprising at least two of the following nozzle insert types: a spray dispensing nozzle insert; a gel dispensing nozzle insert; and a foam dispensing nozzle insert. An embodiment of a foam dispensing nozzle insert is shown in FIGS. 7-13. An embodiment of a gel dispensing nozzle insert is shown in FIGS. 14-20. An embodiment of a spray dispensing nozzle insert is shown in FIGS. 21-26.

Depending on the product to be dispensed, the common aerosol actuator 3 can be assembled with a specific type of nozzle insert which makes the aerosol dispensing cap suitable for dispensing the specific product. The foam dispensing nozzle insert, the gel dispensing insert and the spray dispensing insert are distinct from each other. They have a specific design which allows them to respectively dispense foam, gel or spray in a proper way if assembled with the aerosol actuator 3 and mounted on the aerosol container. The way the nozzle insert is mounted in the actuator 3 is the same for all the nozzle insert types.

If the aerosol dispensing cap has to be suitable for dispensing spray from an aerosol container, the insert of FIGS. 21-26 can be used. The spray dispensing nozzle insert is indicated by reference numeral 400.

The spray nozzle insert 400 comprises an end wall 411 having a spray orifice 412 therethrough. The end wall 411 has an outer side 411A and an inner side 411B. A cylindrical wall 413 connected to the inner side 411B of the end wall 411 surrounds the spray orifice 412 and is arranged concentrically with the spray orifice 412.

The end wall 411 of the spray nozzle insert 400 has substantially an oblong shape, which is best seen in FIGS. 25 and 26. Snap fingers 414 extend from opposite smaller sides of the oblong shape. In this embodiment the snap fingers 414 have the same width as the smaller sides of the oblong end wall 411.

The snap fingers 414 are located at a radial distance outside the cylindrical wall 413. Each snap finger 414 has a snap member 415 which is able to hook behind a complementary hooking edge in the actuator 3.

The actuator 3 has at least two first guiding ribs 30 spaced apart from an outer side of the circumferential wall 19 of the nozzle head 9 configured to guide each snap finger 414 upon positioning the spray nozzle insert 400 in the actuator 3. Each snap finger 414 has a snap member 415 which, in a fully inserted state, is snapped behind an inward end 31 of the first guiding rib 30. The inward end 31 of the first guiding rib 30 is thus the aforementioned complementary hooking edge.

The spray nozzle insert 400 is positioned in the actuator 3, wherein the cylindrical wall 413 of the spray nozzle 400 insert is located in the annular chamber 20 of the nozzle head 9. The flat end surface 21 of the central post 18 is in abutment with a portion of the inner side 411B of the end wall 411 that is situated within the contour of the cylindrical wall 413.

The aerosol cap 1 can be provided in the same way as outlined in the above with a foam dispensing nozzle insert 200 shown in FIGS. 7-13.

The foam dispensing nozzle insert 200 comprises an end wall 211 having an orifice 212 therethrough. The end wall 211 has an outer side 211A and an inner side 211B. A cylindrical wall 213 is connected to the inner side 211B of the end wall and surrounds the orifice 212. A circumferential wall 216 connected to the outer side 211A of the end wall 211 is arranged such that the orifice 212 is located within the perimeter of the circumferential wall 216. The circumferential wall has a generally oblong, more or less rectangular shape. In the specific embodiment shown, the long sides 216A of the rectangle are curved, such that the outer side thereof is convex, which is best seen in FIG. 11. The short sides 216B are straight. Parallel partition walls 217 are formed within the perimeter of the circumferential wall 216. The partition walls 217 each have ends 217A that are connected to the circumferential wall 216. The partition walls 217 define foam expansion chambers 218 with the circumferential wall 216 and the end wall 211. The foam expansion chambers 218 are open on a side remote from the end wall 211. The orifice 212 is in communication with each one of the foam expansion chambers 218.

The foam dispensing nozzle insert 200 is positioned in the actuator 3, in the same way as the spray nozzle insert 400 is positioned in the actuator. The cylindrical wall 213 of the foam dispensing nozzle insert 200 is located in the annular chamber 20 of the nozzle head 9 (cf. FIG. 4). The flat end surface 21 of the central post 18 is in abutment with the inner side 211B of the end wall 211 of the foam dispensing nozzle insert 200.

The foam dispensing nozzle insert 200 has at least two snap fingers 214 located at a radial distance outside the cylindrical wall 213. The snap fingers 214 extend from the inner side of the end wall 211. The actuator 3 has the guiding ribs 30 spaced apart from an outer side of the circumferential wall 19 of the nozzle head 9 as described already in the above. The guiding ribs 30 are configured to guide each snap finger 214 upon positioning the nozzle insert 200 in the actuator 3. The snap finger 214 has a snap member 215 which is snapped behind the inward end 31 of the guiding rib 30 in a fully inserted state.

The orifice 212 is formed as a slot in the end wall 211. The slot extends through the wall within the perimeter of the cylindrical wall 213. In the outer side 211A of the end wall 211 groove-shaped extensions 219 of the through slot 212 are formed. The slot 212 and the groove extensions 219 extend in a direction transverse, in particular perpendicular to the partition walls 217. The slot 212 is in communication with each of the expansion chambers 218 as can be best seen in FIG. 11.

When foam is dispensed through the flow channel 8 in the central post 18, the foam will be distributed in the slot 212 and the groove extensions 219 of the slot 212. The walls 217 which cross the slot 212 will prevent a direct flow locally and facilitates the foam distribution into the slot 212 and groove expansions 219 and therethrough into the foam expansion chambers 218. The expansion chambers 218 are filled with the expanding foam and will be expelled from the expansion chambers 218. In the embodiment shown in the figures, there are two partition walls 217 thus providing three expansion chambers 218. The respective flows of foam flowing out of the respective expansion chambers 218 join each other outside the expansion chambers 218, remote of the end wall 211 of the foam dispensing nozzle insert 200. The foam partially flows from the slot 212 into the rear side of the partition walls 217 (see FIG. 10), which creates a resistance. Also the expansion chambers 219 create a resistance for the flow of foam. By theses resistances a better quality of foam is achieved.

The aerosol cap 1 can be provided in the same way with a gel dispensing nozzle insert 300 shown in FIGS. 14-20.

The gel dispensing nozzle insert 300 comprises an end wall 311 having an orifice 312 therethrough. The orifice 312 has an elongate, preferably round, shape, in particular an oval or elliptic shape. The end wall 311 has an outer side 311A and an inner side 311B. A first cylindrical wall 313 connected to the inner side 311B of the end wall 311 is arranged around the orifice 312, in particular concentric with the orifice 312. A second cylindrical wall 316, which is connected to the outer side 311A of the end wall 311, is arranged concentric with the orifice 312.

The gel dispensing nozzle insert 300 is positioned in the actuator 3 in the same way as the spray nozzle insert 400 is positioned in the actuator 3. The first cylindrical wall 313 of the gel dispensing nozzle insert 300 is located in the annular chamber 20 of the nozzle head 9. The flat end surface 21 of the central post 18 is in abutment with the inner side of the end wall 311 of the nozzle insert 300 within the perimeter of the wall 313, which is indicated by reference numeral 311C. There are thus two contact surfaces 311 which contact the end surface 21 of the central post 18. Between the contact surfaces 311C a recess 311D is formed on either end of the elliptic or oval shape. The recesses 311D provide additional space for the gel that is dispensed and that expands when it flows out of the dispensing channel 8.

The gel dispensing nozzle insert 300 has at least two snap fingers 314 located at a radial distance outside the first cylindrical wall 313. The snap fingers 314 extend from the inner side 311B of the end wall 311. The actuator 3 has the guiding ribs 30 spaced apart from an outer side of the circumferential wall 19 of the nozzle head 9 as described already in the above. The guiding ribs 30 are configured to guide each snap finger 314 upon positioning the nozzle insert 300 in the actuator 3. The snap finger 314 has a snap member 315 which is snapped behind the inward end 31 of the guiding rib 30 in a fully inserted state.

The aerosol caps 1 that are produced by assembling the common actuator 3 and the different nozzle inserts 200, 300, 400, which are described in the above, are preferably well recyclable. In order to allow for good recyclability, the aerosol caps are preferably entirely made from the same material, or at least from compatible materials. In particular the aerosol caps 1 are made by injection moulding one or more parts from the same plastic material. Preferably the cap 1 including the nozzle insert 200, 300, 400 of one of the above-described types is made of a suitable polypropylene (PP) blend. The nozzle inserts 200, 300, 400 can thus be made in an injection moulding process using a PP blend. The other parts of the cap 1, i.e. the cap body 2 and the actuator 3 can be made in one piece in an injection moulding process, or can be made separately by injection moulding and then assembled. Also for the cap body 2 and the actuator a polypropylene (PP) is a suitable material.

The aerosol caps 1 provided with one of the respective nozzle inserts 200, 300, 400 are placed on an aerosol container containing the corresponding substance, i.e. foam, gel or spray forming liquid.

A particular application for a foam dispensing aerosol cap 1 as described in the above can be assembled with a pressurized container which contains a foam forming substance, which is dispensed as a foam, which foam is for personal care such as for example shaving foam, haircare foam, body care foam, e.g. shower foam.

A particular application for a gel dispensing aerosol cap 1 as described in the above can be assembled with a pressurized container which contains a gel forming substance, which is dispensed as a gel, which gel is for personal care such as for example shaving gel, shower gel or hair gel.

1. A Method for producing an aerosol dispensing device adapted for placement on an aerosol container having a valve stem of an operable valve at the top of the container, comprising the steps:
providing an actuator adapted to operate the valve stem of the container and including a flow channel having an inlet end adapted to be coupled with the valve stem of the aerosol container and an outlet end, wherein the actuator has a nozzle head at the outlet end of the flow channel, the nozzle head having a receiving chamber,
providing a range of different nozzle insert types, said range comprising at least two of the following different nozzle insert types:
a spray dispensing nozzle insert,
a gel dispensing nozzle insert,
a foam dispensing nozzle insert,
selecting one of the nozzle insert types of the range, and
assemble the nozzle insert of the selected type with the actuator by positioning the nozzle insert in the receiving chamber of the nozzle head of the actuator.

2. The method according to claim 1, wherein the nozzle inserts of the nozzle insert types within said range are made by injection moulding.

3. The method according to claim 2, wherein the nozzle inserts are made from a polypropylene (PP).

4. The method according to claim 1, wherein the actuator is made by injection moulding.

5. The method according to claim 4, wherein the actuator is made from a polypropylene (PP).

6. An aerosol dispensing device for placement on an aerosol container having a valve stem of an operable valve at the top of the container,
the aerosol dispensing device comprising:
an actuator adapted to operate the valve stem of the container and including a flow channel having an inlet end adapted to be coupled with the valve stem of the aerosol container and an outlet end, wherein the actuator has a nozzle head at the outlet end of the flow channel, the nozzle head having a central post and a circumferential wall concentrically surrounding the central post, the central post and the circumferential wall defining between them an annular chamber, wherein the central post has a flat end surface at which the outlet of the flow channel is located,
a gel dispensing nozzle insert comprising an end wall having an orifice therethrough, the end wall having an outer side and an inner side, wherein a first cylindrical wall connected to the inner side of the end wall is arranged surrounding the orifice, and wherein a second cylindrical wall connected to the outer side of the end wall is arranged surrounding the orifice,
the nozzle insert being positioned in the actuator, wherein the first cylindrical wall of the nozzle insert is located in the annular chamber of the nozzle head and the flat end surface of the central post is in abutment with the inner side of the end wall of the nozzle insert,
wherein the nozzle insert has at least two snap fingers located at a radial distance outside the first cylindrical wall, said snap fingers extending from the inner side of the end wall, wherein the actuator has at least two first guiding ribs spaced apart from an outer side of the circumferential wall of the nozzle head configured to guide each snap finger upon positioning the nozzle insert in the actuator, wherein the snap finger has a snap member which is snapped behind an inward end of the first guiding rib in a fully inserted state.

7. The aerosol dispensing device according to claim 6, wherein the orifice has an elongate shape.

8. The aerosol dispensing device according to claim 6, wherein the orifice has an elliptic shape or oval shape.

9. An aerosol dispensing device for placement on an aerosol container having a valve stem of an operable valve at the top of the container,
the aerosol dispensing device comprising:
an actuator adapted to operate the valve stem of the container and including a flow channel having an inlet end adapted to be coupled with the valve stem of the aerosol container and an outlet end, wherein the actuator has a nozzle head at the outlet end of the flow channel, the nozzle head having a central post and a circumferential wall concentrically surrounding the central post, the central post and the circumferential wall defining between them an annular chamber, wherein the central post has a flat end surface at which the outlet of the flow channel is located,
a foam dispensing nozzle insert comprising an end wall having an orifice therethrough, the end wall having an outer side and an inner side, wherein a cylindrical wall connected to the inner side of the end wall is arranged surrounding the orifice, and wherein a circumferential wall connected to the outer side of the end wall is arranged such that the orifice is located within the perimeter of the circumferential wall, and wherein parallel partition walls are formed within the perimeter of the circumferential wall, which partition walls each have ends that are connected to the circumferential wall and which partition walls define foam expansion chambers with the circumferential wall and the end wall, wherein the foam expansion chambers are open on a side remote from the end wall, and wherein the orifice is in communication which each one of the foam expansion chambers,
the nozzle insert being positioned in the actuator, wherein the first cylindrical wall of the nozzle insert is located in the annular chamber of the nozzle head and the flat end surface of the central post is in abutment with the inner side of the end wall of the nozzle insert,
wherein the nozzle insert has at least two snap fingers located at a radial distance outside the first cylindrical wall, said snap fingers extending from the inner side of the end wall, wherein the actuator has at least two first guiding ribs spaced apart from an outer side of the circumferential wall of the nozzle head configured to guide each snap finger upon positioning the nozzle insert in the actuator, wherein the snap finger has a snap member which is snapped behind an inward end of the first guiding rib in a fully inserted state.

10. The aerosol dispensing device according to claim 9, wherein the orifice is formed as a slot in the end wall, which extends through the wall within the perimeter of the cylindrical wall, wherein the slot extends in a direction transverse, in particular perpendicular to the partition walls.

11. The aerosol dispensing device according to claim 10, wherein groove-shaped extensions of the slot are formed in the outer side of the end wall, which groove-shaped extensions are in fluid communication with the slot and, preferably, extend in line with the slot.

12. An assembly of an aerosol container having a valve stem of an operable valve at the top of the container and containing a foam forming substance, and an aerosol dispensing device which is placed on the aerosol container, the aerosol dispensing device comprising:
an actuator adapted to operate the valve stem of the container and including a flow channel having an inlet end adapted to be coupled with the valve stem of the aerosol container and an outlet end, wherein the actuator has a nozzle head at the outlet end of the flow channel, the nozzle head having a central post and a circumferential wall concentrically surrounding the central post, the central post and the circumferential wall defining between them an annular chamber, wherein the central post has a flat end surface at which the outlet of the flow channel is located,
a foam dispensing nozzle insert comprising an end wall having an orifice therethrough, the end wall having an outer side and an inner side, wherein a cylindrical wall connected to the inner side of the end wall is arranged surrounding the orifice, and wherein a circumferential wall connected to the outer side of the end wall is arranged such that the orifice is located within the perimeter of the circumferential wall, and wherein parallel partition walls are formed within the perimeter of the circumferential wall, which partition walls each have ends that are connected to the circumferential wall and which partition walls define foam expansion chambers with the circumferential wall and the end wall, wherein the foam expansion chambers are open on a side remote from the end wall, and wherein the orifice is in communication which each one of the foam expansion chambers,
the nozzle insert being positioned in the actuator, wherein the first cylindrical wall of the nozzle insert is located in the annular chamber of the nozzle head and the flat end surface of the central post is in abutment with the inner side of the end wall of the nozzle insert,
wherein the nozzle insert has at least two snap fingers located at a radial distance outside the first cylindrical wall, said snap fingers extending from the inner side of the end wall, wherein the actuator has at least two first guiding ribs spaced apart from an outer side of the circumferential wall of the nozzle head configured to guide each snap finger upon positioning the nozzle insert in the actuator, wherein the snap finger has a snap member which is snapped behind an inward end of the first guiding rib in a fully inserted state.

13. The assembly according to claim 12, wherein the foam forming substance forms a foam for personal care.

14. An assembly of an aerosol container having a valve stem of an operable valve at the top of the container and containing a gel forming substance, and an aerosol dispensing device, which is placed on the aerosol container, the aerosol dispensing device comprising:
an actuator adapted to operate the valve stem of the container and including a flow channel having an inlet end adapted to be coupled with the valve stem of the aerosol container and an outlet end, wherein the actuator has a nozzle head at the outlet end of the flow channel, the nozzle head having a central post and a circumferential wall concentrically surrounding the central post, the central post and the circumferential wall defining between them an annular chamber, wherein the central post has a flat end surface at which the outlet of the flow channel is located,
a gel dispensing nozzle insert comprising an end wall having an orifice therethrough, the end wall having an outer side and an inner side, wherein a first cylindrical wall connected to the inner side of the end wall is arranged surrounding the orifice, and wherein a second cylindrical wall connected to the outer side of the end wall is arranged surrounding the orifice,
the nozzle insert being positioned in the actuator, wherein the first cylindrical wall of the nozzle insert is located in the annular chamber of the nozzle head and the flat end surface of the central post is in abutment with the inner side of the end wall of the nozzle insert,
wherein the nozzle insert has at least two snap fingers located at a radial distance outside the first cylindrical wall, said snap fingers extending from the inner side of the end wall, wherein the actuator has at least two first guiding ribs spaced apart from an outer side of the circumferential wall of the nozzle head configured to guide each snap finger upon positioning the nozzle insert in the actuator, wherein the snap finger has a snap member which is snapped behind an inward end of the first guiding rib in a fully inserted state.

15. The assembly according to claim 14, wherein the gel forming substance forms a gel for personal care.

16. The assembly according to claim 13, wherein the foam for personal care is one of shaving foam, haircare foam, body care foam.

17. The assembly according to claim 15, wherein the gel for personal care is one of shaving gel, shower gel and hair gel.
